(19) United States
(12) Patent Application Publication
(10) Pub. No.: US 2026/0311490 A1
(43) Pub. Date: Oct. 8, 2026

(54) OBJECT DETECTION PROBABILITY CALCULATING APPARATUS, OBJECT DETECTION PROBABILITY CALCULATING METHOD, AND PROGRAM

(71) Applicant: NTT, Inc., Tokyo (JP)

(72) Inventors: Masanori KOIKE, Tokyo (JP); Noritsugu EGI, Tokyo (JP); Kazuhisa YAMAGISHI, Tokyo (JP)

(73) Assignee: NTT, Inc., Tokyo (JP)

(21) Appl. No.: 19/484,022

(22) PCT Filed: Sep. 21, 2023
(86) PCT No.: PCT/JP2023/034203

§ 371 Date: Nov. 13, 2025

(30) Foreign Application Priority Data
May 22, 2023 (WO) PCT/JP2023/019023

(51) Int. Cl. G06V 20/54; G06T 7/55; G06V 10/98; G06V 20/40; G06V 20/58

(52) U.S. Cl. CPC G06V 20/54; G06T 7/55; G06V 10/993; G06V 20/40; G06V 20/58; G06T 2207/10016; G06T 2207/20076; G06T 2207/30168; G06T 2207/30252

(57) ABSTRACT

The present disclosure aims to calculate the object detection probability of an operator at a monitoring center that monitors automated driving.

To this end, the present disclosure provides an object detection probability calculating apparatus that calculates an object detection probability indicating a percentage of monitors who actually detected an object when multiple monitors viewed monitoring videos based on current and past video quality parameters acquired from an imaging unit installed in a mobile object, and distance information indicating the distance from the mobile object or the imaging unit to a predetermined object.

### TECHNICAL FIELD

This disclosure relates to a technology for calculating the object detection probability of an operator at a monitoring center that monitors automated driving.

### BACKGROUND ART

The market size of automated driving automobiles is expanding due to the development of communication technology, improvements in the accuracy of sensors installed in automobiles, and improvements in automated driving control technology. Automated driving technology is classified into stages from Lv.1 to Lv.5 according to the level of automated driving. In Lv.1 and Lv.2, the driver remains the primary party responsible for driving tasks, and the automated driving system performs auxiliary functions such as lane-keeping assist and braking, but the driver retains responsibility for the driving tasks.

On the other hand, in Lv.3 to Lv.5 of automated driving, the automated driving system of the automobiles primarily manages driving tasks, with the system assuming responsibility for driving tasks. In Lv.4 automated driving, under specific conditions, a driver is not required and accidents due to human errors during driving can be reduced. However, accidents due to system errors may still occur.

Therefore, as means for dealing with system errors, there have been discussions about remotely monitoring the videos from the monitoring cameras for the automated driving and allowing an operator at a monitoring center to remotely operate an automobile depending on the situation (NPL 1). In addition, guidelines from the Ministry of Land, Infrastructure, Transport and Tourism (NPL 2) emphasize that automated automobiles performing automated driving must ensure operational safety by identifying various risks occurring during operations and then selecting appropriate routes and areas. Therefore, when monitoring the monitoring videos transmitted from the monitoring cameras for the automated driving, the operator at the monitoring center must respond appropriately when a dangerous driving situation occurs. For example, in cases where a person, animal, object, or the like jumps out onto the road, or an object that may collide with an automobile is placed on the road, it is necessary for the operator to appropriately identify the objects that may hinder driving and to take control of the automobile remotely such as bringing the automobile to a stop.

On the other hand, in a situation where an automobile is driving automatedly and transmitting monitoring videos to a monitoring center in real-time, the quality of the monitoring videos may degrade due to fluctuations in the bandwidth of wireless communication. If the quality of the monitoring videos deteriorates, the operator at the monitoring center may not be able to detect objects that may hinder driving, which may lead to accidents. Therefore, if the video quality does not meet certain criteria in automated driving, it is considered necessary to take measures such as bringing the automobile to a stop in advance. To establish the criteria of video quality required for object detection, it is necessary to confirm the object detection probability (the percentage of monitors who actually detect objects when multiple monitors view the monitoring videos) when parameters that affect the quality, such as the video bitrate, are input. ITU-T Recommendation P.1204 (NPL 3) outlines a method for estimating the quality perceived by users from the bitrate of streaming videos. On the other hand, in the case of object detection for automated driving, the video quality perceived by users in general streaming videos is not sufficient. Instead, the video quality required is one that allows operators to detect objects from monitoring videos.

However, in conventional monitoring video transmissions in automated driving, the quality of monitoring videos transmitted by the automobile may deteriorate due to changes in wireless bandwidth or the like. In such cases, automated driving may continue even though the operator's object detection probability remains low. For example, the screen of the operator terminal at the monitoring center is split and small monitoring videos from multiple automobiles are displayed simultaneously. Thus, the operator at the monitoring center may not notice deteriorations in the video quality.

In addition, when detecting objects using monitoring videos, it is necessary to take into account the distance between the object and the automobile. For example, the closer an object is to an automobile, the larger it appears in videos. Therefore, even if the video quality has degraded, the operator's object detection probability may not be low.

Given the above, a technology for estimating object detection probabilities based on the distance to objects is highly desirable.

### CITATION LIST

### Non-Patent Literature

NPL 1: Supplementary Explanation Document for Final Evaluation of Research and Development and Demonstration Projects for Social Implementation of Advanced Automated driving and MaaS, 2021, ITS/Automated Driving Promotion Office, Automotive Division, Manufacturing Industries Bureau, Ministry of Economy, Trade and Industry
NPL 2: Guidelines for ensuring safety and convenience in unmanned automated driving services in designated areas, Ministry of Land, Infrastructure, Transport, and Tourism NPL 3: P.1204: Video quality assessment of streaming services over reliable transport for resolutions up to 4K, ITU-T, 2020

### SUMMARY OF INVENTION

### Technical Problem

When transmitting video in real-time, it is expected that the bitrate will be dynamically changed according to changes in the wireless bandwidth. In order to estimate the object detection probability in such an environment, an estimation technology that can handle the fluctuations in the bitrate is required. For example, when the bitrate at a certain time T is low, even if the operator at the monitoring center cannot detect an object located X meters [m] away at that moment, when the video was played back at a higher bitrate at a previous time, the operator at the monitoring center might have detected the object at that position at a moment before time T.

In addition, in an automated driving system, the speed of the automobile is not always constant but fluctuates. The faster the automobile speed, the faster the movements of the background and other objects in the monitoring video. When there is large (fast) movement within the video, it becomes difficult to encode the video. Thus, even if the video is transmitted from the automobile to the monitoring center at the same bitrate, the video quality may decrease and the object detection probability may decrease. In addition, when the automobile is moving fast, the distance traveled by the automobile increases during the time between the time the automobile detects an object and the time the operator takes action. Thus, there is a need to detect the object at an earlier stage.

The present disclosure has been made in consideration of the above circumstances, and an object thereof is to calculate the object detection probability of the operator at the monitoring center.

### Means for Solving the Problem

To achieve the above object, the present disclosure provides an object detection probability calculating apparatus that calculates an object detection probability indicating a percentage of monitors who actually detected an object when multiple monitors viewed monitoring videos based on current and past video quality parameters obtained from an imaging unit installed in a mobile object and distance information indicating a distance from the mobile object or the imaging unit to a predetermined object.

### Advantageous Effects of Invention

As described above, the present disclosure has the effect of being able to calculate the object detection probability by operators at a monitoring center.

### BRIEF DESCRIPTION OF DRAWINGS

FIG. 1 is an overall configuration diagram of a communication system according to a first embodiment.

FIG. 2 is a diagram showing an example of a model showing the relationship between an object detection probability and an assumed object distance with respect to the bitrate of a video.

FIG. 3 is a diagram showing an example of a model showing the relationship between an object detection probability and an assumed object distance with respect to the speed of a mobile object.

FIG. 4 is a diagram showing input information when the bitrate is fixed and the speed is variable.

FIG. 5 is a diagram showing input information when the bitrate is variable and the speed is fixed.

FIG. 6 is a diagram showing input information when the bitrate is variable and the speed is also variable.

FIG. 7 is an electrical hardware configuration diagram of each device and terminal according to the embodiment.

FIG. 8 is a flowchart showing a process of estimating and presenting an object detection probability according to the first embodiment.

FIG. 9 is a diagram showing an example of a display screen on an operator terminal at a monitoring center.

FIG. 10 is an overall configuration diagram of a communication system according to a modification of the first embodiment.

FIG. 11 is an overall configuration diagram of a communication system according to a second embodiment.

FIG. 12 is a flowchart showing a process for estimating and presenting an object detection probability according to the second embodiment.

FIG. 13 is a diagram showing the overall configuration of a communication system according to a modification of the second embodiment.

### DESCRIPTION OF EMBODIMENTS

Hereinafter, embodiments of the present invention will be described with reference to the drawings.

### First Embodiment

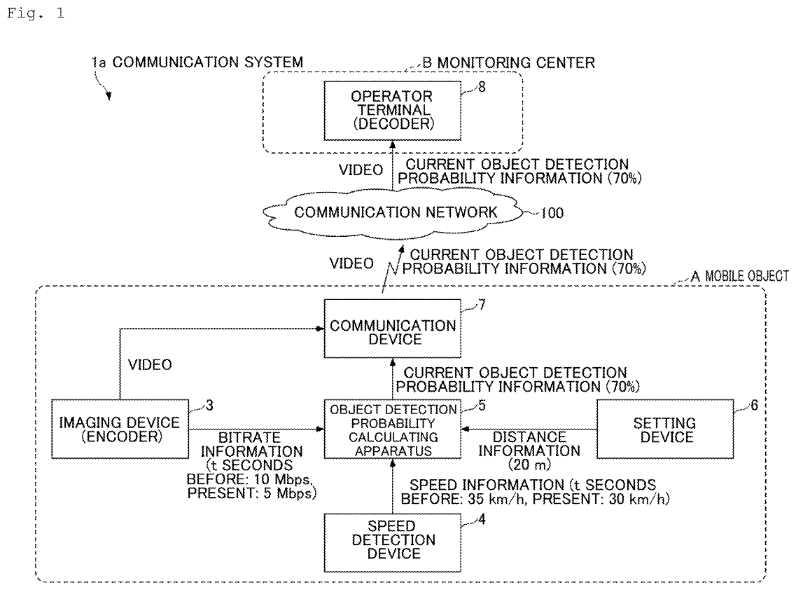

The first embodiment will be described with reference to FIGS. 1 to 9.

### System Configuration of First Embodiment

The outline of the configuration of a communication system 1a according to the first embodiment will be described with reference to FIG. 1. FIG. 1 is an overall configuration diagram of a communication system according to the first embodiment. Note that the values shown in FIG. 1 (10 Mbps, 5 Mbps, 30 km/h, 35 km/h, 20 m, 70%) are merely examples and are not limited to these.

As shown in FIG. 1, the communication system 1a is constructed by each device (imaging device 3, speed detection device 4, object detection probability calculating apparatus 5, setting device 6, and communication device 7) mounted on a mobile object A that can move automatically, such as a vehicle, and an operator terminal 8 placed on a remote monitoring center B side.

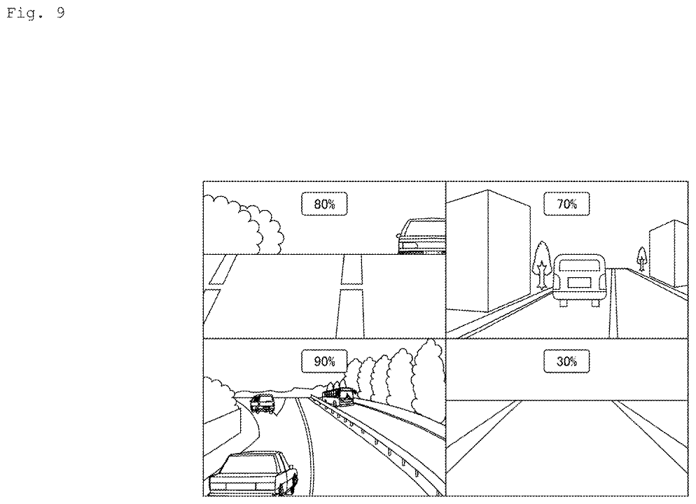

Basically, the mobile object A performs automated driving, but the operator at the monitoring center B can monitor the movement status of each mobile object by displaying videos from multiple mobile objects on the operator terminal 8 of the monitoring center B, as shown in FIG. 9, and the operator can remotely operate a specific mobile object according to the movement status. This allows the operator to remotely avoid an accident when an object or person that interferes with driving appears while viewing the video from a predetermined mobile object.

Note that there may be multiple imaging devices 3, speed detection devices 4, object detection probability calculating apparatuses 5, setting devices 6, communication devices 7, and operator terminals 8. In particular, the system may include four or more imaging devices 3 for capturing videos of the front, right side, left side, and rear of the mobile object A.

In this embodiment, the mobile object A is assumed to be, for example, a vehicle (automobile) having a communication function and an automated driving function. However, the mobile object A is not limited to an automobile, and may be an agricultural machine such as a tractor having a communication function and an automated driving function. The mobile objects may also be ships, aircraft, and the like, in addition to vehicles.

Among these, the imaging device 3 has a camera mounted on the mobile object A and an encoder for compressing video data, encodes video data obtained by capturing videos of the surroundings of the mobile object A, and transmits the encoded data to the communication device 7. Furthermore, the imaging device 3 has a bitrate extraction function, extracts the video bitrate from the encoded video data, and transmits bitrate information indicating the bitrate per unit time t (for example, 1 second) to the object detection probability calculating apparatus 5. Note that the imaging device 3 and the encoder (device) may be separate entities.

The speed detection device 4 detects the moving speed (for example, kilometers per hour) of the mobile object A and transmits speed information indicating the detected speed to the object detection probability calculating apparatus 5. This speed information is also transmitted every unit time t, similar to the bitrate information.

The object detection probability calculating apparatus 5 has a calculation unit (first calculation unit) that calculates the object detection probability based on the current and past bitrate information acquired from the imaging device 3, the speed information acquired from the speed detection device 4, and the distance information acquired from the setting device 6. This calculation unit is a function that is realized by executing a program. The object detection probability indicates the percentage of monitors who actually detected (recognize) an object when multiple monitors view a monitoring video, and can also be indicated as an object recognition rate. For example, if there are 100 monitors with various visual acuity levels, and 50 of them are able to detect an object appearing in the monitoring videos, the object detection probability would be 50%. Then, the object detection probability calculating apparatus 5 transmits current object detection probability information indicating the calculated object detection probability to the operator terminal 8 at the monitoring center B via the communication device 7. As a result, the operator terminal 8 displays the object detection probability information (80% or the like) for each mobile object together with the video (monitoring video) from each mobile object, as shown in FIG. 9 described below. The method of calculating the object detection probability will be explained in detail later.

The setting device 6 is a device for setting distance information used to calculate the object detection probability in the object detection probability calculating apparatus 5. The distance information indicates the distance between the mobile object A (or the imaging device 3) and the object, and is a predetermined fixed value such as 10 m, 20 m, or 30 m.

The communication device 7 can communicate data with the operator terminal 8 via the communication network 100. The communication network 100 is constructed by a mobile network, the Internet, and the like. The Internet also includes the space Internet that transmits data through outer space using artificial satellites and the like.

The operator terminal 8 is a terminal such as a personal computer (PC) used by an operator at the monitoring center B. The operator terminal 8 has a decoder for decoding encoded video data.

### [Detailed Method of Calculating Object Detection Probability]

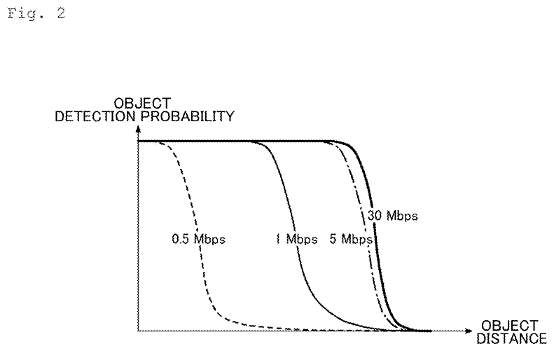

Next, a method of calculating the object detection probability calculated in the object detection probability calculating apparatus 5 will be described with reference to FIGS. 2 to 6. Here, a method for calculating the object detection probability dr using the bitrate br, speed v, and distance d between the mobile object A (or the imaging device 3) and the object of the video input to the device will be described.

<Relationship Between Object Detection Probability and Object Distance with Respect to Bitrate>

Video quality is correlated with the bitrate, and the higher the bitrate, the higher the video quality. The corresponding relationship between object distance and object detection probability with respect to bitrate is shown in FIG. 2. FIG. 2 is a diagram showing an example of a model (first object detection probability model) showing the relationship between the object detection probability with respect to the video bitrate and the assumed object distance.

The higher the bitrate, the higher the object detection probability for the same object distance. On the other hand, when the bitrate reaches a certain level or higher, the video quality almost reaches the upper limit, and the object detection probability does not change even at bitrates higher than that. Therefore, the object detection probability calculating apparatus 5 calculates the object detection probability using an object detection probability model in which the object detection probability increases as the bitrate increases, but the object detection probability hardly changes when the bitrate is equal to or higher than a predetermined value (first predetermined value). Furthermore, the object detection probability calculating apparatus 5 calculates the object detection probability using an object detection probability model in which the object detection probability is high when the distance between the mobile object A and the object is equal to or less than a predetermined value (second predetermined value) (relatively close), and the object detection probability is equal to or greater than a certain value even when the bitrate is equal to or less than a predetermined value (third predetermined value) (relatively low). On the other hand, the object detection probability calculating apparatus 5 calculates the object detection probability using an object detection probability model (first object detection probability model) in which the object detection probability decreases as the distance between the mobile object A and the object increases, and the object detection probability becomes 0 when the distance is equal to or greater than a predetermined value (fourth predetermined value) (too far).

The object detection probability calculating apparatus 5 calculates the object detection probability using the first object detection probability model, based on the current and past parameters and the above-mentioned distance.

<Relationship between object detection probability and assumed object distance with respect to speed>

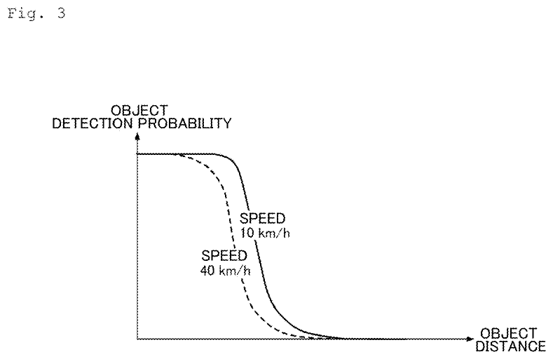

In addition, using the speed of the mobile object A as input, the system can output detection probabilities that vary depending on changes in the speed of the mobile object A. FIG. 3 is a diagram showing an example of a model (second object detection probability model) showing the relationship between the object detection probability and the assumed object distance with respect to the speed of a mobile object. FIG. 3 shows the relationship between the object detection probability and the object distance when the mobile object A travels at speeds of 40 km/h and 10 km/h. When the speed of the mobile object A is high, the movement of the background and objects in the video becomes large (fast), making it difficult to encode the video. Therefore, even if the video is distributed at the same bitrate, it is considered that the video quality will decrease and the object detection probability will decrease, and therefore the object detection probability calculating apparatus 5 calculates the object detection probability using this characteristic. In addition, when the speed of the mobile object A is high, even if the distance to the object when it is displayed in the video is the same, the distance that the mobile object A moves until a human such as an operator detects the object will be longer. Therefore, it is considered that the assumed object distance in the object detection probability will be shorter, and therefore the object detection probability calculating apparatus 5 calculates the object detection probability using this characteristic.

The object detection probability calculating apparatus 5 has a calculation unit (second calculation unit) that uses a second object detection probability model to calculate the object detection probability based on the current and past speeds and the above-mentioned distance. This calculation unit is a function that is realized by executing a program.

The object detection probability calculating apparatus 5 may also have a calculation unit (third calculation unit) that uses the first object detection probability model and the second object detection probability model to calculate the object detection probability based on the current and past parameters, the current and past speeds, and the above-mentioned distance. This calculation unit is a function that is realized by executing a program.

### <Method of Calculating Object Detection Probability by Object Detection Probability Calculating Apparatus>

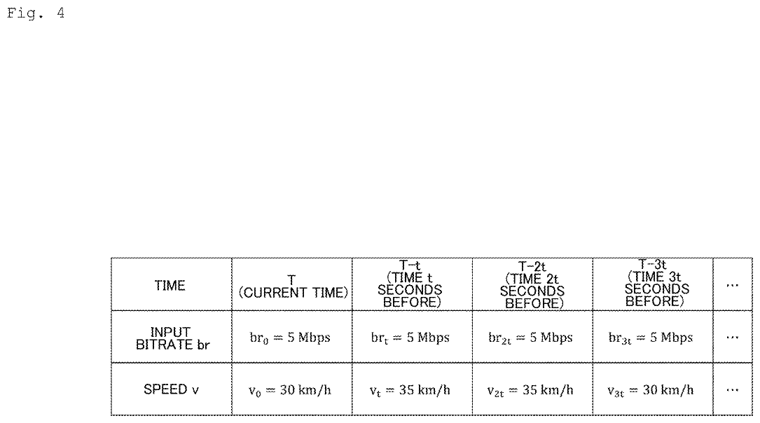

Next, the method of calculating the object detection probability by the object detection probability calculating apparatus 5 will be described with reference to FIGS. 4 to 6. The method of calculating the detection probability when bitrate information and speed information are actually input to the object detection probability calculating apparatus 5 will be described in detail.

Here, the formula of the object detection probability calculated by the current bitrate, current speed, and distance from the current object is used as a reference, and this is used to calculate the object detection probability when at least one of the bitrate and speed changes. First, the reference object detection probability is calculated using the current bitrate (br), speed (v), and distance from the object (d). If the formula for calculating the object detection probability is expressed as the formula f(br, v, d) with bitrate information, speed information, and distance information as input, the object detection probability dr is expressed by Formula 1 using the function f.

$$[ Math . 1 ]$$

$$dr = f ( br , v , d ) \qquad ( Formula 1 )$$

As shown in FIGS. 2 and 3, the function f(br, v, d) has the characteristics that the object detection probability, which is the output, increases as the distance d decreases, and further has the above-mentioned properties regarding the bitrate and speed. Based on this point, f(br, v, d) is calculated using one of the following formulas. Note that f(br, v, d) is defined in the range from 0 to 1, and in each of the formulas below, if f(br, v, d) is 0 or less, the object detection probability is 0, and if f(br, v, d) is 1 or more, the object detection probability is 1.

Note that the formula used to calculate the object detection probability is not limited to the one shown below.

$$[ Math . 2 ]$$

$$dr = \frac{( {a}_{1} - A )}{1 + exp \frac{br - {x}_{0}}{{a}_{2}}} + A - {a}_{3} \times {e}^{d} \qquad ( Formula 2 )$$

$$[ Math . 3 ]$$

$$dr = A ( 1 - {b}^{( br - {a}_{1} )} ) + {x}_{0} \times d \qquad ( Formula 3 )$$

$$[ Math . 4 ]$$

$$dr = {x}_{0} ⋆ A ( 1 - exp ( - \frac{br}{{a}_{1} \times d} ) ) + A ( 1 - exp ( - \frac{br}{{a}_{2} \times d} ) ) \qquad ( Formula 4 )$$

$$[ Math . 5 ]$$

$$dr = - ( A + {x}_{0} exp ( - \frac{br}{{a}_{1} \times d} ) ) \qquad ( Formula 5 )$$

$$[ Math . 6 ]$$

$$dr = {a}_{1} - \frac{{( br - {x}_{0} )}^{A}}{{a}_{2}^{A} + {( br - {x}_{0} )}^{A}} \qquad ( Formula 6 )$$

$$[ Math . 7 ]$$

$$dr = \frac{1}{1 + {( \frac{br - {x}_{0}}{{a}_{1}} )}^{A}} \qquad ( Formula 7 )$$

$$[ Math . 8 ]$$

$$dr = ( 1 - {a}_{3} \times {e}^{d} ) - \frac{( 1 - {a}_{3} \times {e}^{d} ) - {a}_{4}}{{( 1 + \frac{br}{{a}_{1} \times {e}^{d}} )}^{{a}_{z}}} \qquad ( Formula 8 )$$

$$[ Math . 9 ]$$

$$dr = \frac{{a}_{1}}{1 + exp A ( d - {x}_{0} )} \qquad ( Formula 9 )$$

Note that x₀ and A in Formula 9 are expressed as follows.

$${x}_{0} = {b}_{1} \times log ( {b}_{2} + br ) + {b}_{3} - ( {b}_{4} + {b}_{5} \times log ( {b}_{6} + br ) ) \times v$$

$$A = - {c}_{1} \times log ( {c}_{2} + br ) + {c}_{3} + ( {c}_{4} - {c}_{5} \times log ( {c}_{6} + br ) ) \times v$$

Alternatively, A may be expressed as follows.

$$A = - {c}_{1} \times exp ( - ( {c}_{2} \times {x}_{0} ) - {c}_{3} ) + {c}_{4}$$

Here, in Formula 2 to Formula 9, a₁ to a₄, b₁ to b₆, and c₁ to c₆ are coefficients that differ for each equation. Also, e represents the base of the natural logarithm. Here, by setting the coefficients according to conditions such as the size of the object, the size of the display, the size of the object shown on the display, and the weather, it is possible to estimate the object according to the driving conditions and the monitoring environment.

### <Past Bitrate and Speed>

Next, how the object detection probability calculating apparatus 5 inputs video bitrate information and mobile object A speed information in chronological order at each of the times t seconds before, 2 t seconds before, and so on the current time, and calculates the current object detection probability using this information, assuming that the current time is T will be described.

### (Fixed Bitrate and Variable Speed)

FIG. 4 shows input information when the bitrate is fixed and the speed is variable. FIG. 4 shows an example in which the bitrate brₓ at each time is fixed at 5 Mbps, but the speed is variable. As shown in FIG. 4, the current bitrate is br₀, the current speed is v₀, the bitrate t seconds before was brₜ (=br₀), the speed t seconds before was vₜ, the bitrate 2 t seconds before was brat (=br₀), the speed 2 t seconds before was v₂ₜ, and so on. And it is assumed that the bitrate information and the speed information are input to the object detection probability calculating apparatus 5 at each time.

Here, since the speed differs at each time, the distance of the mobile object A from the object at the past time is calculated based on the speed at each time. If the distance moved by the mobile object A from nt seconds before to the current time is taken as the correction distance dcₙₜ, the correction distance is calculated, for example, by Formula 10.

$$[ Math . 10 ]$$

$${dc}_{nt} = {\sum }_{k = 0}^{n - 1} t \cdot {v}_{kt} \qquad ( Formula 10 )$$

The object detection probability calculating apparatus 5 uses this Formula 10 to calculate the object detection probability nt seconds before (n=1, 2, . . . ). However, at past times, the position of the mobile object A at the current time is different from that at the past time, and the mobile object A was in a position closer than the current time, so the detection distance needs to be corrected according to the speed. If the distance to be corrected from the current distance at time T-nt, nt seconds before the current time T, is set to dcₙₜ, the object detection probability fₙₜ at nt seconds before is expressed as Formula 11 below.

$$[ Math . 11 ]$$

$${f}_{nt} = f ( br , {v}_{nt} , d + {dc}_{nt} ) \qquad ( Formula 11 )$$

The current object detection probability is calculated taking into account the current and past object detection probabilities. When bitrate information up to Nt seconds before is input, the object detection probability dr is expressed as Formula 12 below. Note that although N=3 is used in FIG. 4, the value of N is not limited to N=3.

$$[ Math . 12 ]$$

$$dr = {\sum }_{k = 0}^{N} {b}_{kt} {f}_{kt} \qquad ( Formula 12 )$$

(when Bitrate is Variable and Speed is Fixed)

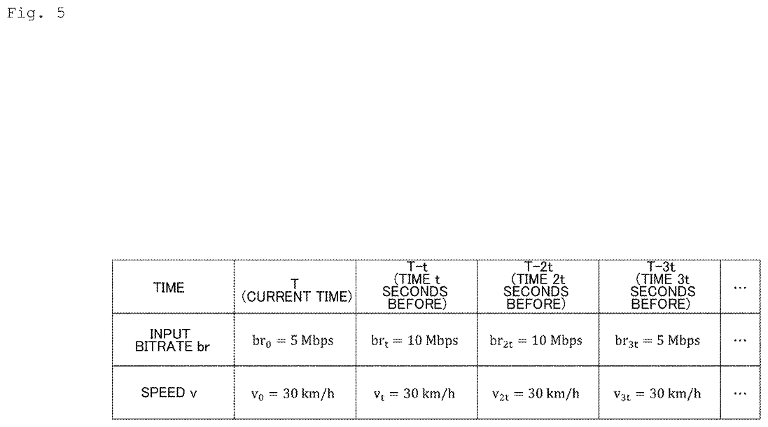

FIG. 5 shows input information when the bitrate is variable and the speed is fixed. FIG. 5 shows an example where the bitrate brₓ varies at each time, but the speed is fixed at 30 km/h. As shown in FIG. 5, the current bitrate is br₀, the current speed is v₀, the bitrate t seconds before is brₜ, the speed t seconds before is vₜ (=v₀), the bitrate 2 t seconds before is brat, the speed 2 t seconds before is v₂ₜ (=v₀), and so on. And it is assumed that the bitrate information and the speed information are input to the object detection probability calculating apparatus 5 at each time.

Here, when the bitrate change is not taken into consideration, the object detection probability can be expressed as f(br₀, v₀, d) based on the bitrate and the speed at the current time T. On the other hand, t seconds before, a video with a bitrate of 10 Mbps, which is higher than the current bitrate of 5 Mbps, is being played. In this case, since the object detection probability for an object located d meters away at the current time T is equal to or lower than a predetermined value, even if the operator has difficulty detecting the object, there is a possibility that the object could have been detected t seconds before.

Therefore, in order to find the possibility that the same object could have been detected at the past time, the object detection probability calculating apparatus 5 calculates the object detection probability nt seconds before (n=1, 2, . . . ). However, at the past time, since the position of the mobile object A differs from its current position and is located closer to its previous position, it is necessary to adjust the detection distance according to the speed in such cases as well. If the distance to be corrected from the current distance at time T-nt, nt seconds before the current time T, is denoted as dcₙₜ, the object detection probability fₙₜ at nt seconds before is expressed as Formula 13.

$$[ Math . 13 ]$$

$${f}_{nt} = f ( {br}_{nt} , {v}_{nt} , d + {dc}_{nt} ) \qquad ( Formula 13 )$$

Here, since the correction distance dcₙₜ is expressed as the product of time and speed (in this case, the hourly speed) when the hourly speed is constant, the object detection probability calculating apparatus 5 calculates it using Formula 14 below.

$$[ Math . 14 ]$$

$${dc}_{nt} = {v}_{0} t \qquad ( Formula 14 )$$

The current (present) object detection probability is calculated taking into account the current and past object detection probabilities. When bitrate information up to Nt seconds before is input, the object detection probability dr is expressed by Formula 12. Note that although N=3 is used in FIG. 5, the value of N is not limited to N=3.

Here, bₖₜ is a function that weights the current and past object detection probabilities, and is a value defined between 0 and 1. If the past bitrate was high and the past object detection probability was high, the operator at the monitoring center B can remotely grasp the situation at the site even if the current bitrate is low and the current object detection probability is low. In this case, when detecting an object located d meters away at the current time T, the object detection probability calculating apparatus 5 may select the maximum of the past and current object detection probabilities. In that case, it can be expressed by Formula 15.

$$[ Math . 15 ]$$

$$dr = max ( {f}_{kt} \vert k = 0 , 1 , 2 , … , N ) \qquad ( Formula 15 )$$

(when Both Bitrate and Speed are Variable)

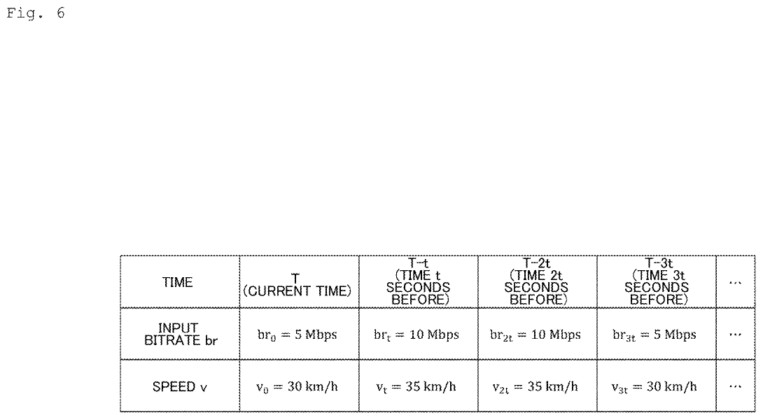

FIG. 6 shows input information when the bitrate and the speed are variable. In FIG. 6, as an example, the bitrate brₓ at each time varies and the speed also varies. As shown in FIG. 6, the current bitrate is br₀, the current speed is v₀, the bitrate t seconds before is brₜ, the speed t seconds before is vₜ, the bitrate 2 t seconds before is br₂ₜ, the speed 2 t seconds before is v₂ₜ, and so on. And it is assumed that bitrate information and speed information are input to the object detection probability calculating apparatus 5 at each time. In this case, similar to the case of the bitrate fluctuating in FIG. 5, the object detection probability is calculated taking into account the bitrate in the past video. On the other hand, unlike the case of only the bitrate fluctuating, the speed also fluctuates, so similar to the case of the speed fluctuating in FIG. 4, the object detection probability calculating apparatus 5 needs to calculate the correction distance dcₙₜ using the past speed at each time. Therefore, the object detection probability calculating apparatus 5 can calculate the object detection probability dr by combining both the formulas used when only the speed fluctuates and when only the bitrate fluctuates. That is, at nt seconds before, the correction distance dcₙₜ is expressed by Formula 10, and the object detection probability fₙₜ is expressed by Formula 13.

The current object detection probability is expressed by, for example, Formula 12 or Formula 15 using these Formula 10 and Formula 13.

Here, bₖₜ is a function that weights the current and past object detection probabilities, and is a value defined between 0 and 1.

When the object detection probability calculating apparatus 5 calculates the object detection probability with the speed of the mobile object A fixed (constant), the speed detection device 4 may be omitted. In this case, the speed information is set in the object detection probability calculating apparatus 5 in advance. When the object detection probability calculating apparatus 5 calculates the object detection probability with the bitrate of the video fixed (constant), the imaging device 3 does not need to extract the bitrate. In this case, the bitrate is set in the object detection probability calculating apparatus 5 in advance.

### [Hardware Configuration]

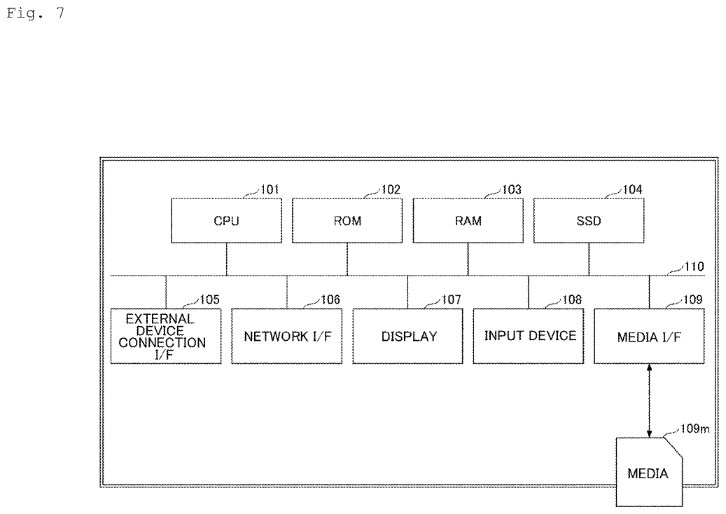

Next, the electrical hardware configuration of the object detection probability calculating apparatus 5, the setting device 6, the communication device 7, and the operator terminal 8 will be described with reference to FIG. 7. FIG. 7 is a diagram showing the electrical hardware configuration of each device and terminal according to the embodiment. As shown in FIG. 7, the object detection probability calculating apparatus 5 is a computer that includes a CPU 101, a ROM 102, a RAM 103, an SSD 104, an external device connection interface (I/F) 105, a network I/F 106, a display 107, an input device 108, a media I/F 109, and a bus line 110. Among these components, the CPU 101 controls the overall operation of the object detection probability calculating apparatus 5. The ROM 102 stores programs used to drive the CPU 101 such as an IPL. The RAM 103 is used as a work area of the CPU 101.

The SSD 104 reads out or writes various types of data in accordance with control of the CPU 101. Meanwhile, a hard disk drive (HDD) may be used instead of the SSD 104.

The external device connection I/F 105 is an interface for connecting various external devices. The external devices in this case may be a display, a speaker, a keyboard, a mouse, a USB memory, or a printer.

The network I/F 106 is an interface for data communication via the communication network 100.

The display 107 is a type of display means such as liquid crystal or organic electro luminescence (EL) that displays various images.

The input device 108 is a button, a switch, a keyboard, a pointing device, or the like, and is an example of an input means for accepting input operations such as characters, numbers, and various instructions.

The media I/F 109 controls reading or writing (storage) of data to a recording medium 109m such as a flash memory. Examples of the recording medium 109m also include a DVD, and a Blu-ray Disc (registered trademark).

The bus line 110 is an address bus, a data bus, or the like for electrically connecting each component such as the CPU 101 illustrated in FIG. 7.

Note that the setting device 6, the communication device 7, and the operator terminal 8 have the same configuration as the object detection probability calculating apparatus 5, so their description will be omitted.

### Processing or Operation of Communication System According to First Embodiment

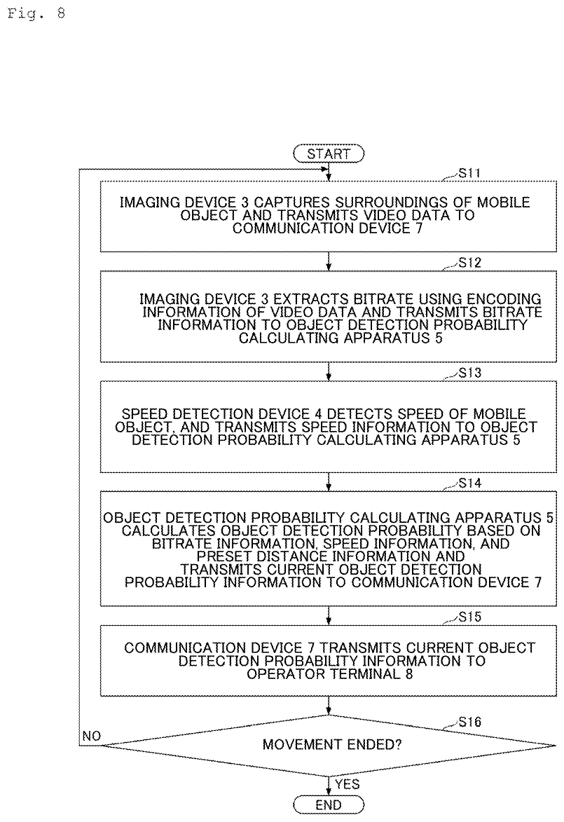

Next, the processing or operation of each device of the communication system 1a will be described with reference to FIGS. 8 and 9. FIG. 8 is a flowchart showing the processing of estimating and presenting the object detection probability according to the first embodiment. FIG. 9 is a diagram showing an example of a display screen of an operator terminal at a monitoring center.
S11: The imaging device 3 captures the surroundings of the mobile object A to obtain video data, compresses the video data using an encoder, and transmits the compressed video data to the communication device 7. The communication device 7 then transmits the video data to the operator terminal 8 via the communication network 100.
S12: The imaging device 3 extracts the video bitrate using the encoding information of the video data, and transmits the bitrate information (for example, 5 Mbps, 10 Mbps) to the object detection probability calculating apparatus 5.
S13: The speed detection device 4 detects the current speed of the mobile object A and transmits speed information indicating this speed to the object detection probability calculating apparatus 5.
S14: The object detection probability calculating apparatus 5 uses at least one of the model shown in FIG. 2 and the model shown in FIG. 3 to calculate the current object detection probability (for example, 70%) based on the bitrate information, speed information, and preset distance information (for example, 20 m). Then, the object detection probability calculating apparatus 5 transmits object detection probability information indicating the current object detection probability to the communication device 7.
S15: The communication device 7 transmits the current object detection probability information to the operator terminal 8 via the communication network 100.

As a result, as shown in FIG. 9, the operator terminal 8 decodes the video data transmitted from each mobile object by the process S11 on the display, associates the object detection probability information related to the video of each mobile object transmitted from the communication device 7 by the process S15, and displays the decoded video data on a split-screen format. In order to associate the video with the object detection probability information, identification information such as an ID may be included in each of the video data and the object detection probability information. In this case, the imaging device 3 adds the identification information to the video data and the bitrate information to be output. Then, the object detection probability calculating apparatus 5 adds the identification information added to the bitrate information acquired from the imaging device 3 to the object detection probability information and outputs it.
S16: If the movement of the mobile object A has not ended (NO), the process returns to the process S11. On the other hand, if the movement of the mobile object A has ended (YES), the process shown in FIG. 8 ends.

### Modification of System Configuration of the First Embodiment

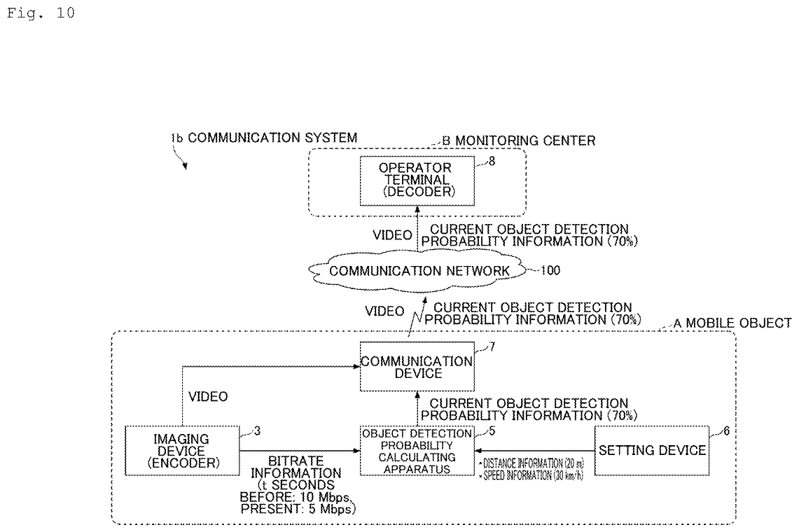

Next, a communication system 1b according to a modification of the first embodiment will be described with reference to FIG. 10. FIG. 10 is an overall configuration diagram of a communication system according to a modification of the first embodiment. Note that the values shown in FIG. 10 (10 Mbps or the like) are merely examples, as in FIG. 1, and are not limited to these.

This modification is different from the case of FIG. 1 in that the speed information (for example, 30 km/h) is set in advance by the setting device 6 without using the speed detection device 4 and transmitted to the object detection probability calculating apparatus 5. That is, this modification shows an example in which the speed of the mobile object A is fixed (constant).

### Effects of First Embodiment and Modification

As described above, according to the first embodiment, the object detection probability of the operator at the monitoring center B can be obtained and presented. As a result, the operator terminal 8 at the monitoring center B displays the monitoring video from each mobile object in association with the object detection probability information of this monitoring video as shown in FIG. 9, so that the situation in which the operator does not notice the deterioration of the video quality of the monitoring video can be eliminated.

In addition, even if the current object detection probability is below a predetermined value, the bitrate of the past video and the past speed of the mobile object A are tracked (considered) to calculate the current object detection probability, making it easier for the operator to recognize the object.

### Second Embodiment

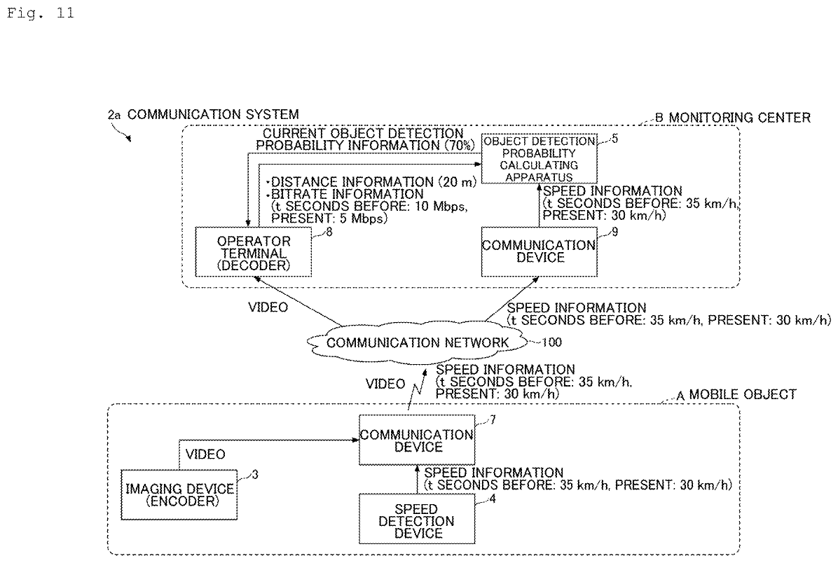

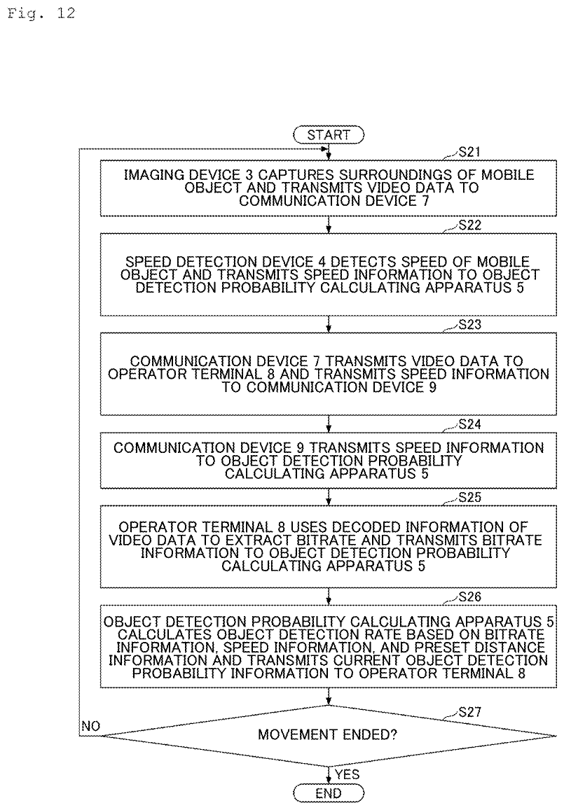

Next, the second embodiment will be described with reference to FIGS. 11 and 12.

### System Configuration of Second Embodiment

Next, a communication system 2a according to the second embodiment will be described with reference to FIG. 11. FIG. 11 is an overall configuration diagram of the communication system according to the second embodiment. Note that the values (10 Mbps or the like) shown in FIG. 11 are examples, as in FIG. 1, and are not limited to these. Also, the same devices or terminals as those in FIG. 1 are given the same reference numerals and their description will be omitted.

In the communication system 2a in FIG. 11, the object detection probability calculating apparatus 5 on the mobile object A side is installed on the monitoring center B side, and a communication device 9 is installed in the monitoring center B accordingly. Video data encoded by the imaging device 3 is transmitted to the operator terminal 8 via the communication device 7. However, in this embodiment, the operator terminal 8, rather than the imaging device 3, has the bitrate extraction function. Moreover, the mobile object A does not have a setting device 6, and instead the distance is set in advance in the operator terminal 8 and transmitted to the object detection probability calculating apparatus 5. Furthermore, the speed information indicating the fluctuating speed of the mobile object A detected by the speed detection device 4 of the mobile object A is transmitted to the object detection probability calculating apparatus 5 via the communication device 7 and the communication device 9. This transmission is performed every unit time t (for example, 1 second).

The object detection probability calculating apparatus 5 calculates the current object detection probability based on the distance information, bitrate information, and speed information, as in the first embodiment, and transmits it to the operator terminal 8.

### Processing or Operation of Communication System According to Second Embodiment

Next, the processing or operation of each device of the communication system 2a will be described with reference to FIG. 12. FIG. 12 is a flowchart showing the processing of estimating and presenting the object detection probability according to the second embodiment.
S21: The imaging device 3 captures the surroundings of the mobile object A to obtain video data, and then compresses the video data using an encoder and transmits it to the communication device 7. Then, the communication device 7 transmits the video data to the operator terminal 8 via the communication network 100.
S22: The speed detection device 4 detects the current speed of the mobile object A and transmits speed information indicating this speed to the object detection probability calculating apparatus 5.
S23: The communication device 7 transmits the video data to the operator terminal 8 and also transmits the speed information to the communication device 9.
S24: The communication device 9 transmits the speed information to the object detection probability calculating apparatus 5.
S25: The operator terminal 8 extracts the video bitrate using the encoding information of the video data and transmits the bitrate information (for example, 5 Mbps, 10 Mbps) to the object detection probability calculating apparatus 5.
S26: The object detection probability calculating apparatus 5 uses at least one of the models shown in FIGS. 2 and 3 to calculate the current object detection probability (for example, 70%) based on the bitrate information, the speed information, and the preset distance information (for example, 20 m). Then, the object detection probability calculating apparatus 5 transmits object detection probability information indicating the current object detection probability to the operator terminal 8.

As a result, as shown in FIG. 9, the operator terminal 8 decodes the video data transmitted from each mobile object in the process S23, associates the object detection probability information related to the video of each mobile object transmitted from the object detection probability calculating apparatus 5 in the process S26, and displays the decoded video data in a split-screen format. In this case, in order to associate the video with the object detection probability information, each of the video data and the object detection probability information may include identification information such as an ID. In this case, the imaging device 3 adds the identification information to the video data to be output. Then, when the operator terminal 8 extracts the bitrate, the same identification information is added to the bitrate information. The object detection probability calculating apparatus 5 adds the identification information added to the bitrate information acquired from the operator terminal 8 to the object detection probability information and transmits it to the operator terminal 8.
S27: If the movement of the mobile object A has not ended (NO), the process returns to the process S21. On the other hand, if the movement of the mobile object A has ended (YES), the process shown in FIG. 12 ends.

### Modification of System Configuration of Second Embodiment

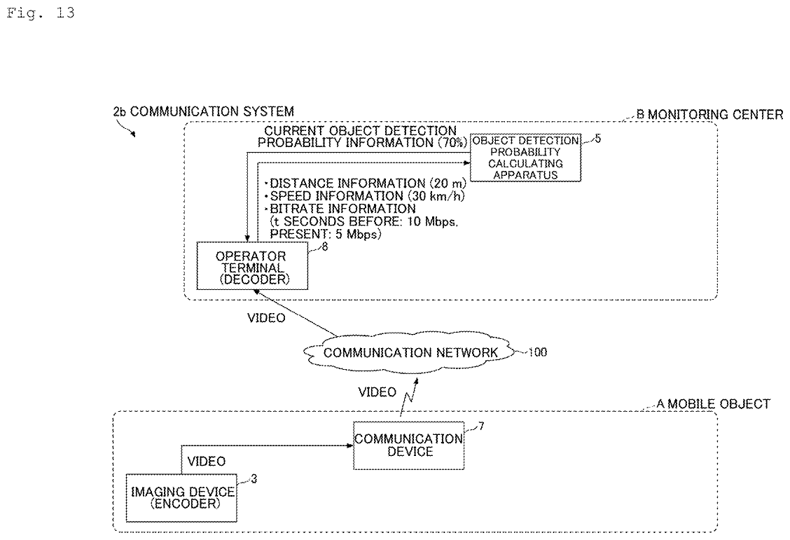

Next, a communication system 2b according to a modification of the second embodiment will be described with reference to FIG. 13. FIG. 13 is an overall configuration diagram of a communication system according to a modification of the second embodiment. Note that the values shown in FIG. 13 (10 Mbps or the like) are merely examples, as in FIG. 1, and are not limited to these.

This modification differs from the case of FIG. 1 in that the speed information (for example, 30 km/h) is set in advance by the setting device 6 and transmitted to the object detection probability calculating apparatus 5 without using the speed detection device 4. That is, this modification shows an example in which the speed of the mobile object A is fixed (constant).

### Effects of Second Embodiment and Modification

As described above, the second embodiment provides the same effects as the first embodiment. Furthermore, the second embodiment and its modification require fewer devices on the mobile object A side compared to the first embodiment and its modification, and therefore provides the effect of reducing the initial cost for receiving the remote monitoring and remote control services by the communication systems 2a and 2b.

### Supplement

As described above, this embodiment is not limited to the above embodiment, and various modifications and applications are possible, for example, as shown below.
(1) In the above embodiment, the imaging device 3 or the operator terminal 8 extracts the bitrate from the video data and transmits the bitrate information, and the object detection probability calculating apparatus 5 calculates the object detection probability using the bitrate information, but the present invention is not limited to the above. For example, the imaging device 3 or the operator terminal 8 may transmit resolution information indicating the resolution of the video or frame rate information indicating the frame rate of the video instead of the bitrate information, and the object detection probability calculating apparatus 5 may calculate the object detection probability using the resolution information or frame rate information instead of the bitrate information. The bitrate information, resolution information, and frame rate information are examples of video quality parameters.
(2) Each device can be realized by a computer and a program, but the program can be recorded on a (non-transitory) recording medium or provided via a communication network such as the Internet.
(3) The CPU 101 may be a single unit or multiple units.

### RELATIONSHIP TO BASIC APPLICATION

This patent application claims priority based on the international patent application PCT/JP2023/019023 filed on May 22, 2023, and the entire contents of the international patent application PCT/JP2023/019023 are incorporated herein by reference.

### REFERENCE SIGNS LIST

1a, 1b, 2a, 2b Communication system
A Mobile object
B Monitoring center
3 Imaging device
4 Speed detection device
5 Object detection probability calculating apparatus
6 Setting device
7 Communication device
8 Operator terminal
9 Communication device
100 Communication network

1. An object detection probability calculating apparatus comprising:
a processor; and
a memory that includes instructions, which when executed, cause the processor to execute:
calculating an object detection probability indicating a percentage of monitors who actually detected an object when multiple monitors viewed monitoring videos based on current and past video quality parameters obtained from an imaging unit installed in a mobile object and distance information indicating a distance from the mobile object or the imaging unit to a predetermined object.

2. The object detection probability calculating apparatus according to claim 1, wherein the instructions, which when executed, cause the processor to execute:
using a first object detection probability model that indicates a relationship between the object detection probability, and a distance from the mobile object or from an imaging device provided on the mobile object to the predetermined object with respect to video quality parameters related to videos to calculate the object detection probability based on the parameters and the distance.

3. An object detection probability calculating apparatus comprising:
a processor; and
a memory that includes instructions, which when executed, cause the processor to execute:
calculating an object detection probability indicating a percentage of monitors who actually detected an object when multiple monitors viewed monitoring videos based on a speed of the mobile object obtained from a speed detection device installed in the mobile object and a distance from the mobile object to a predetermined object.

4. The object detection probability calculating apparatus according to claim 3, wherein the instructions, which when executed, cause the processor to execute:
using a second object detection probability model that indicates a relationship between the object detection probability and the distance with respect to the speed of the mobile object to calculate the object detection probability based on the speed and the distance.

5. An object detection probability calculating apparatus comprising:
a processor; and
a memory that includes instructions, which when executed, cause the processor to execute:
calculating an object detection probability indicating a percentage of monitors who actually detected an object when multiple monitors viewed monitoring videos based on video quality parameters related to videos acquired by an imaging device installed in the mobile object, a speed of the mobile object obtained from a speed detection device installed in the mobile object, and a distance from the mobile object or the imaging device to a predetermined object.

6. The object detection probability calculating apparatus according to claim 5, wherein the instructions, which when executed, cause the processor to execute:
using a first object detection probability model that indicates a relationship between the object detection probability and the distance with respect to the parameters and a second object detection probability model that indicates a relationship between the object detection probability and the distance with respect to the speed of the mobile object to calculate the object detection probability based on the parameters, the speed, and the distance.

7. An object detection probability calculating apparatus comprising:
a processor; and
a memory that includes instructions, which when executed, cause the processor to execute:
calculating an object detection probability indicating a percentage of monitors who actually detected an object when multiple monitors viewed monitoring videos based on current and past video quality parameters related to videos acquired by an imaging device installed in the mobile object, current and past speeds of the mobile object acquired from a speed detection device installed in the mobile object, and a distance from the mobile object or the imaging device to a predetermined object.

8. An object detection probability calculating method executed by a computer, comprising:
calculating an object detection probability indicating a percentage of monitors who actually detected an object when multiple monitors viewed monitoring videos based on current and past video quality parameters acquired from an imaging unit installed in a mobile object, and distance information indicating a distance from the mobile object or the imaging unit to a predetermined object.

9. A non-transitory computer-readable recording medium having computer-readable instructions stored thereon, which when executed, cause a computer to execute the method according to claim 8.
